(19) United States
(12) Patent Application Publication
(10) Pub. No.: US 2012/0090192 A1
(43) Pub. Date: Apr. 19, 2012

(54) METHOD FOR DRYING MICROFIBRILLATED CELLULOSE

(75) Inventors: Hans Henrik Oevreboe, Sarpsborg (NO); Jens-Uwe Wichmann, Sarpsborg (NO); Anne Opstad, Sarpsborg (NO); Synnoeve Holtan, Sarpsborg (NO)

(73) Assignee: BORREGAARD INDUSTRIES LIMITED, NORGE, Sarpsborg (NO)

(21) Appl. No.: 13/255,405

(22) PCT Filed: Mar. 10, 2010
(86) PCT No.: PCT/EP2010/001496

§ 371 Date: Dec. 21, 2011

Related U.S. Application Data
(60) Provisional application No. 61/159,207, filed on Mar. 11, 2009.

(30) Foreign Application Priority Data
Mar. 11, 2009 (EP) 09003574.2
Mar. 11, 2009 (EP) 09003575.9
Mar. 11, 2009 (EP) 09003576.7
Mar. 11, 2009 (EP) 09003577.5
Nov. 25, 2009 (EP) 09014690.3

(51) Int. Cl. F26B 5/06

(52) U.S. Cl. 34/285; 34/72

(57) ABSTRACT

The invention relates to a method for drying microfibrillated cellulose, comprising at least the following steps: (i) applying a composition comprising microfibrillated cellulose and a liquid onto a cold surface; (H) removing the frozen composition formed in step (i) from said surface to form frozen particles; (iii) optionally increasing the size of the frozen particles formed in step (ii); (iv) drying the frozen particles formed in step (iii) comprising: subjecting said particles to a cold moving gas thus removing liquid by means comprising sublimation and optionally (v) isolating the microfibrillated cellulose formed in step (iv). The invention also relates to a device for carrying out the method of the invention.

The present invention relates to a method and a device for drying microfibrillated cellulose.

In one embodiment, the method for drying microfibrillated cellulose according to the present invention comprises at least the following steps:
(i) applying a composition comprising microfibrillated cellulose and at least one liquid onto a surface that is sufficiently cold to at least partially freeze said composition, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream.

In a preferred embodiment, said surface has a temperature that is not below −150° C., preferably not below −120° C. or not below −100° C.

In a preferred embodiment, the method additionally comprises step (v):
(v) isolating dried microfibrillated cellulose formed in step (iv).

The present invention also relates to a device for drying microfibrillated cellulose, wherein, in one embodiment, said device at least comprises:
(F) means comprising a surface that is sufficiently cold to at least partially freeze a composition comprising microfibrillated cellulose and at least one liquid, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(A) means for applying said composition comprising microfibrillated cellulose and at least one liquid onto means (F);
(R) means for removing frozen composition from said surface of means (F) and for forming frozen particles;
(C) means for containing frozen particles from means (R) while optionally allowing for the addition of at least one liquid or a composition comprising said at least one liquid and microfibrillated cellulose to said particles, and while allowing for access of a cold moving gas stream;
(D) means for drying particles contained in means (C), said means (D) providing a cold moving gas stream.

Preferably, said cold surface in step (i) or in means (F) has a temperature of at least 30 K below the melting point of the at least one liquid, or, if the at least one liquid is a mixture of two or more liquids, at least 30 K below the melting point of the liquid with the lowest melting point.

Further preferably, said cold moving gas stream in step (iv) or in means (C) and (D) is held at a temperature less than 10 K above the melting point of the at least one liquid, or, if the at least one liquid is a mixture of two or more liquids, less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

Therefore, in another embodiment, the method for drying microfibrillated cellulose according to the present invention comprises at least the following steps:
(i) applying a composition comprising microfibrillated cellulose and at least one liquid onto a cold surface that has a temperature of at least 30 K below the melting point of the at least one liquid, or, if the at least one liquid is a mixture of two or more liquids, at least 30 K below the melting point of the liquid with the lowest melting point, wherein said surface has a temperature that is not more than 150 K below the melting point of the at least one liquid, or if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream, wherein said cold moving gas stream is held at a temperature of less than 10 K above the melting point of the at least one liquid, or, if the at least one liquid is a mixture of two or more liquids, of less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

In a preferred embodiment, said surface has a temperature that is not below −150° C., preferably not below −120° C. or not below −100° C.

The present invention therefore also relates to a device for drying microfibrillated cellulose, wherein, in another embodiment, said device at least comprises:
(F) means comprising a surface that is kept at a temperature of at least 30 K below the melting point of the at least one liquid, or, if the at least one liquid is a mixture of two or more liquids, at least 30 K below the melting point of the liquid with the lowest melting point, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(A) means for applying a composition comprising microfibrillated cellulose and at least one liquid onto means (F);
(R) means for removing frozen composition from said surface of means (F) and for forming frozen particles;
(C) means for containing frozen particles from means (R) while optionally allowing for the addition of at least one liquid or a composition comprising at least one liquid and microfibrillated cellulose to said particles, and while allowing for access of a cold moving gas stream;
(D) means for drying particles contained in means (C), said means (D) providing a cold moving gas stream,
   wherein said cold moving gas stream in means (C) and (D) is held at a temperature of less than 10 K above the melting point of the at least one liquid, or, if the at least one liquid is a mixture of two or more liquids, of less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

In a preferred embodiment, said composition comprises microfibrillated cellulose in particulate form, which is suspended or is dispersed or is present as a colloid in said at least one liquid.

In a preferred embodiment that applies in combination with any of the embodiments disclosed in the present invention, said microfibrillated cellulose is in particulate form and has a characteristic length in the range of 1 μm to 5,000 μm, preferably 100 μm to 3,000 μm, further preferably 500 μm to 3,000 μm, further preferably 1000 μm to 3,000 μm.

It is preferred that said microfibrillated cellulose has an average length in any of the ranges given above and an average diameter in the nanometer range, preferably from 1 nm to 100 nm, further preferably from 5 nm to 50 nm.

Said “characteristic” length/diameter is the largest length or diameter measurable in case the particle is asymmetric/of irregular shape.

### BACKGROUND OF THE INVENTION

Microfibrillated cellulose (MFC) is a valuable product derived from cellulose and is commonly manufactured in a process in which cellulose fibers are opened up and unraveled to form fibrils and microfibrils/nanofibrils by (repeated) passage through a geometrical constraint, preferably in a homogenizer.

In a homogenizer, a slurry comprising cellulose and liquid is forced through an orifice of a certain opening while being subjected to sizeable pressure drop.

Such microfibrillated cellulose is known from the art, for example from U.S. Pat. No. 4,374,702 (“Turbak”). According to Turbak, microfibrillated cellulose has properties distinguishable from celluloses known previously and is produced by passing a liquid composition of cellulose through a small diameter orifice in which the composition is subjected to a pressure drop of at least 3000 psig and a high velocity shearing action followed by a high velocity decelerating impact. The passage of said composition through said orifice is repeated until the cellulose composition becomes a substantially stable composition. This process converts the cellulose into microfibrillated cellulose without substantial chemical change of the cellulose starting material.

Another process for manufacturing microfibrillated cellulose is described in U.S. Pat. No. 5,385,640 (“Weibel”). Weibel provides a relatively simple and inexpensive means for refining fibrous cellulosic material into a dispersed tertiary level of structure and thereby achieving the desirable properties attendant with such structural change. The cellulosic fiber produced in this way is referred to as “microdenominated cellulose (MDC)”, a sub-group of micro-fibrillated cellulose. Microfibrillated cellulose is therein obtained by repeatedly passing a liquid composition of fibrous cellulose through a zone of high shear, which is defined by two opposed surfaces, with one of the surfaces rotating relative to the other, under conditions and for a length of time sufficient to render the composition substantially stable and to impart to the composition a water retention that shows consistent increase with repeated passage of the cellulose composition through the zone of high shear.

WO 2007/091942 (“STFI”) describes a method for treatment of chemical pulp for the manufacturing of microfibrillated cellulose comprising the following steps: a) providing a hemicellulose containing pulp, b) refining said pulp in at least one step and treating said pulp with one or more wood degrading enzymes at a relatively low enzyme dosage, and c) homogenizing said pulp thus providing said microfibrillated cellulose. As far as the manufacture of microfibrillated cellulose is concerned, the respective content of WO 2007/091942 is incorporated into the present disclosure by reference.

The application of homogenizers usually requires to pass a suspension of cellulose in a liquid (the so-called pulp) several times through said homogenizers to increase the viscosity in order to develop a gel structure, until no further increase in viscosity is achieved. After such a treatment, homogeneous MFC is obtained and the conversion of cellulose to microcellulose as such is concluded. The microfibrillated cellulose is present as a composition of microfibrils in a liquid.

In addition to microfibrillated cellulose prepared by mechanical means as described above, bacterial microfibrillated cellulose or MFC obtained in any other way is also included.

MFC has unique properties and leads to important commercial products that are utilized in a wide range of industrial applications such as specialty paper manufacturing, paints and gel coat formulating, additives in the food industry, galenics and formulation in the pharmaceutical industry and in cosmetics applications, among others.

In order to be valuable to customers, for example in the food industries or in the paint industries, the microfibrillated cellulose is preferably provided as a dried gel or as a dry powder that can be reconstituted without significant loss of properties, in particular without significant loss of viscosity respectively gel-like structure vis-à-vis “never dried” microfibrillated cellulose.

The state of the art for specifically for freezing gels can be described as follows: Keeping the complete pore structure of a gel from e.g. silica, is only possible by vitrification. Vitrification means the direct transfer of the liquid into an amorphous state either through extremely quick freezing (Mega-Kelvin per second) or the use of cryoprotectants and massive undercooling (lowering the freezing temperature); (see, e.g., Freezing gels' in Journal of Non-Crystalline Solids 155 (1993), 1-25).

Freezing of gels of dissolved cellulose, e.g. in NMMO, as described in ‘Synthesis and characterization of nanofibrillar cellulose arerogels’ (Cellulose (2008) 15:121-129) is done by immersion freezing in liquid nitrogen or by contact freezing of a metal surface that was cooled down with liquid nitrogen (Nanofibrillar cellulose aerogels in Physiochem. Eng. Aspects 240 (2004), 63-67).

Both approaches refer to gels that are based on dissolved matter, either inorganic or organic.

In comparison to the gels described in the state of the art, in one aspect of the present invention, the material is not dissolved but forms a gel having the features of dispersed particles. In a preferred embodiment, these particles are microfibers that are characterized by one of the following, among others:
Large aspect ratio (>1000).
Low average aggregate size (<50 micron).
High specific surface area as measured with physiosorption methods as BET.
High water retention value.

This gel is typically formed by the interactions of microfibrils forming a stable 3-dimensional network.

Vitrification methods cannot be used for this type of gel since cryoprotectants (anti-freeze materials) contaminate the material for almost all applications and are expensive. Moreover, the energy required for achieving the necessary sub-cooling is too high. All other means to reach ultra-high freezing are only possible on lab-scale and would be prohibitively expensive.

Since the MFC gel consists of fibrils, the expectation of the person skilled in the art is that simple freezing methods, e.g. a deep freezer, could be used. Those freezers work for other dispersions of organic matter, e.g. in food related dispersions. But the methods common for food freezing, e.g. with cold air in a freezer or with air blast freezing in a tunnel freezer are not viable (see Comparative Example 1 given below). The structure of the network was destroyed completely using one of these methods and, in particular, redispersion of the microfibrillated cellulose in the pertinent solvent after drying was not possible.

Immersion freezing in liquid nitrogen, on the other hand, worked to a certain degree. Nevertheless, even with this method, only parts of the characteristics of the network could be recovered after freezing and drying. Moreover, this method is prohibitively expensive, since about 4 kg of liquid nitrogen are necessary to freeze down 1 kg of water in immersion freezers available on the market.

In summary, the conventional process used in the laboratory for drying microfibrillated cellulose is freeze-drying the gel using liquid nitrogen (for freezing) and vacuum (for drying via sublimation). While this process can be suitably implemented on the laboratory stage, high costs for liquid nitrogen and fine vacuum render this process prohibitive for commercial implementation in regard to effectively separating MFC from large amounts of liquid. Additionally, long drying times add costs to said process.

Another drying process for MFC is described in WO 2005/028752. Therein, the suspension of MFC is first dewatered by compression means and then dried in a conventional drying oven operating at a temperature of 60° C. to 120° C.

An object to be addressed by the present invention in view of the known prior art is therefore to provide an improved method for drying microfibrillated cellulose that reduces the high costs of the drying processes or other disadvantages known from the prior art.

### SUMMARY OF THE INVENTION

This object, and others, is/are addressed by a method for drying microfibrillated cellulose, said method comprising at least the following steps:
(i) applying a composition comprising microfibrillated cellulose and at least one liquid onto a surface that is sufficiently cold to at least partially freeze said composition, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream.

In a preferred embodiment, the method additionally comprises step (v):
(v) isolating dried microfibrillated cellulose formed in step (iv).

In a preferred embodiment, said surface has a temperature that is not below −150° C., preferably not below −120° C. or not below −100° C.

In a preferred embodiment, said sequence of steps is performed in the specific order indicated, i.e. optional step (v) after step (iv) after optional step (iii) after step (ii) after step (i).

This object is also solved by a method for drying microfibrillated cellulose comprising at least the following steps:
(i) applying a composition comprising microfibrillated cellulose and at least one liquid onto a surface that has a temperature of at least 30 K below the melting point of the at least one liquid, or, if the at least one liquid is a mixture of two or more liquids, at least 30 K below the melting point of the liquid with the lowest melting point, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream, wherein said cold moving gas stream is held at a temperature of less than 10 K above the melting point of the at least one liquid, or, if the at least one liquid is a mixture of two or more liquids, of less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

In a preferred embodiment, said surface has a temperature that is not below −150° C., preferably not below −120° C. or not below −100° C.

In a preferred embodiment, the method additionally comprises step (v):
(v) isolating dried microfibrillated cellulose formed in step (iv).

The above-stated object(s) and others is/are also addressed by a device for drying microfibrillated cellulose, said device at least comprising:
(F) means comprising a surface that is sufficiently cold to at least partially freeze a composition comprising microfibrillated cellulose and at least one liquid, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(A) means for applying said composition comprising microfibrillated cellulose and at least one liquid onto means (F);
(R) means for removing frozen composition from said surface of means (F) and for forming frozen particles;
(C) means for containing frozen particles from means (R) while optionally allowing for the addition of at least one liquid or a composition comprising said at least one liquid and microfibrillated cellulose to said particles, and while allowing for access of a cold moving gas stream;
(D) means for drying particles contained in means (C), said means (D) providing a cold moving gas stream.

In a preferred embodiment, said surface has a temperature that is not below −150° C., preferably not below −120° C. or not below −100° C.

This object is also solved by a device for drying microfibrillated cellulose, said device at least comprising:
(F) means comprising a surface that is kept at a temperature of at least 30 K below the melting point of the at least one liquid, or, if the at least one liquid is a mixture of two or more liquids, at least 30 K below the melting point of the liquid with the lowest melting point, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(A) means for applying a composition comprising microfibrillated cellulose and at least one liquid onto means (F);
(R) means for removing frozen composition from said surface of means (F) and for forming frozen particles;
(C) means for containing frozen particles from means (R) while optionally allowing for the addition of at least one liquid or a composition comprising at least one liquid and microfibrillated cellulose to said particles, and while allowing for access of a cold moving gas stream;
(D) means for drying particles contained in means (C), said means (D) providing a cold moving gas stream,
   wherein said cold moving gas stream in means (C) and (D) is held at a temperature of less than 10 K above the melting point of the at least one liquid, or, if the at least one liquid is a mixture of two or more liquids, of less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

In regard to any one of the previously disclosed embodiments, it is further preferred that the microfibrillated cellulose is in particulate form and is suspended or dispersed or is present as a colloid in said at least one liquid.

Dispersions, suspensions or colloids as described above are meant to comprise all dispersions, suspensions and colloids as known in the art.

In a preferred embodiment that applies in combination with any of the embodiments disclosed in the present invention, said microfibrillated cellulose is in particulate form and has a characteristic length in the range of 1 μm to 5,000 μm, preferably 100 μm to 3,000 μm, further preferably 500 μm to 3,000 μm, further preferably 1000 μm to 3,000 μm.

It is preferred that said microfibrillated cellulose has an average diameter in the nanometer range, preferably from 1 nm to 100 nm, further preferably from 5 nm to 50 nm.

The “characteristic” length/diameter is the largest length or diameter measurable in case the particle is asymmetric/irregular.

In a preferred embodiment, said at least one liquid is water, a water-compatible solvent or an organic solvent or any mixture of two or more of said liquids. Preferred liquids are protic liquids, i.e. liquids in which the molecules of the liquid have a dissociable hydrogen atom.

Preferred protic liquids are water, lower alcohols, ethylene glycol and oligo(ethylene glycols), and mixtures of said protic liquids. Therein, the term “lower alcohol” comprises alcohols having from one to 10 carbon atoms in the carbon backbone. Preferred alcohols are methanol, ethanol, the propanol isomers, butanol isomers, and mixtures of said alcohols. The term “oligo(ethylene glycol)” encompasses diethylene glycol, triethylene glycol, tetraethylene glycol, pentaethylene glycol, and mixtures of said glycols. Further suitable liquids are e.g. dimethylsulphoxide and glycerol.

In a preferred embodiment, the liquid used in the method of the invention comprises water in combination with another liquid, preferably one or more of the aforementioned protic liquids.

In a particularly preferred embodiment, the liquid used is water.

In an alternate embodiment that is particularly preferred when the end use of the dried MFC is in the field of polymers, adhesives, coatings, gel coats or paints, the at least one liquid is or comprises an organic solvent, or at least one liquid is an organic solvent.

In another embodiment, the composition comprising microfibrillated cellulose and at least one liquid does not comprise drying additives commonly used to aid the drying process, in particular no cellulose ethers and/or no hydrocolloids as added with the objective to improve the drying process. In the prior art, the addition of as much as 50% to 100% of MFC (relative to the MFC solid content) is required to achieve effective drying. The present invention does not rule out, however, does not require such (amounts of) additives.

Depending on the liquid used, however, the addition of an additive, and also of a drying additive, may be advantageous and therefore within the scope of the present invention.

### DETAILED DESCRIPTION OF THE INVENTION

“Micro fibrillated cellulose” (MFC) in the context of the present invention is any material based on or comprising cellulose fibers that have been reduced in their size to result in microfibrils or nanofibrils.

In accordance with the present invention, the term “microfibrillated cellulose” (MFC) is meant to include all possible physical (adsorbed additives, e.g. tensides, hydrocolloids like CMC or HPEG) and/or chemical (e.g. oxidization, cross bonding, silysation) modifications of the fibrils and fibrils from all possible cellulose or pulp sources.

In the context of the present invention, “dried” microfibrillated cellulose and “drying” microfibrillated cellulose means removing at least some liquid from the starting material used in step (i), which is a composition comprising microfibrillated cellulose in at least one liquid.

In the final product, as much as 50% by weight relative to the overall weight of the final product may remain as liquid, preferably, however, not more than 20%, further preferably not more than 10%. Preferably, at the end of the drying process, in accordance with the present invention, the microfibrillated cellulose is present as an essentially dry powder/solid.

Said dried microfibrillated cellulose, in particular if present as a powder or a solid, may be reconstituted by means of adding the same or any other liquid or liquid mixture, if necessary while employing shear forces and/or means of mixing.

The composition comprising microfibrillated cellulose and at least one liquid may have a dynamic viscosity that is 10 times or 100 times or 1000 times higher than the viscosity of water. Said composition may in particular be present as gel. As an aqueous dispersion or suspension, microfibrillated cellulose preferably has non-Newtonian flow properties, for example displaying shear thinning and a gel-like consistency.

### Preparation of the Composition Comprising Microfibrillated Cellulose

In accordance with the present invention, “microfibrillated cellulose” is meant to include both modified and unmodified microfibrillated cellulose, as well as any mixtures thereof.

Modified microfibrillated cellulose may be physically or chemically modified or both. An example of chemically modified microfibrillated cellulose is microfibrillated cellulose that is, for example, derivatized, for example to lead to MFC ester or ethers. An example of physically modified microfibrillated cellulose comprises MFC with added amphiphilic molecules or the like, wherein these molecules are associated with or adsorbed by the microfibrillated cellulose.

The composition comprising microfibrillated cellulose and at least one liquid as used in step (i) can be prepared according to any methods known in the art, in particular all methods outlined above in the “Background”-section.

Preferably, said composition is produced by subjecting a raw cellulosic fiber material to a homogenizer.

Further preferably, said composition is produced by subjecting a fiber material to a mechanical pretreatment step, in particular a refining step and, in a subsequent step, subjecting the product obtained in said first step to a homogenizer.

Mechanical pretreatment steps, in particular refining steps and homogenizing steps that may be used for producing the composition of microfibrillated cellulose in liquid are known in the art.

As the fiber material, wood pulp, paper pulp, reconstituted pulp, sulphite or Kraft pulp, ether grade pulp, pulp from fruit or from vegetable origin, such as citrus, beets, orange or lemon or tomato pulp, pulp from agricultural waste such as bagasse, and the like, or pulp of annual plants or energy crops may be employed for preparing the composition used in step (i). These types of pulp are known in the art and any mixture of these may be used.

Starting material for the conversion of cellulose to microfibrillated cellulose may be any cellulose pulp, preferably a chemical pulp, further preferably bleached, half-bleached and unbleached sulphite, sulphate and soda pulps, Kraft pulps together with unbleached, half-bleached and bleached chemical pulps, and mixtures of these.

Said pulp may be mechanically or chemically or enzymatically pretreated or may not be pretreated at all.

A particularly preferred source of cellulose is regular, fibre-length pulp, derived from either hardwood or soft-wood, or both types (in mixtures), normally available from a pulping operation, or pre-cut if desired. Preferably, said pulp contains pulp from soft-wood. The pulp may also contain soft-wood of one kind only or a mixture of different soft-wood types. For example, said pulp may contain a mixture of pine and spruce.

### Adjusting the Solid Content

The proportion (i.e. concentration or solid content) of cellulose in the composition as used in step (i) may vary depending, among other factors, on the size or the type of homogenizer used for producing microfibrillated cellulose (or any other equipment in which the cellulose is microfibrillated prior to drying).

The microfibrillated cellulose composition as resulting from the manufacturing step, in particular as obtained from a homogenizer as a gel or as a high viscosity composition typically contains less than about 10% cellulose by weight (“solid content”) relative to the overall weight of the composition, in some instances significantly less than 10%, for example less than 5% or less than 3% by weight.

Prior to starting any drying process, a high solid content would be preferred under economic aspects, since liquid has to be removed from the finely dispersed respectively water-dissolved microfibrillated cellulose in order to obtain a solid dry product.

Therefore, in a preferred embodiment, a solid content adjustment step (0) is employed in the method according to the present invention prior to step (i).

This step is preferably conducted in order to increase or adjust the solid content of the composition comprising MFC prior to freezing/drying steps (i) to (iv).

While it could be expected that as much liquid as possible should be removed in said solid content adjustment step, it was unexpectedly found in preparatory and exemplary tests that more than 50% of the viscosity of the reconstituted MFC may be lost if the solid content is increased, prior to step (i), to or above 15% by weight.

Therefore, without wishing to be bound by a theory, it is believed that an upper limit exists for the concentration of microfibrillated cellulose in liquid that is to be subjected to the present method of drying, in particular to steps (i) to (iv). Specifically, it was found that if the solid content in the composition used in step (i) is too high, loss of viscosity respectively gel-structure may be observed upon re-constitution e.g. in water of microfibrillated cellulose obtained in step (iv).

Accordingly, it is preferred that the concentration of the microfibrillated cellulose in the composition with a liquid as employed in step (i) is from 2% to 15% by weight of micro-fibrillated cellulose (based on the total amount of microfibrillated cellulose and liquid), more preferred from 4% to 10% by weight, more preferred from 5% to 9%.

A particularly preferred concentration range is from 7% to 9% by weight.

Therefore, in a preferred embodiment, the object(s) according to the present invention, is/are addressed by a method for producing microfibrillated cellulose, comprising:

(0) adjusting the solid content of microfibrillated cellulose in a composition comprising said microfibrillated cellulose and at least one liquid to a solid content, i.e. concentration, from 2% to 15% by weight of microfibrillated cellulose relative to the overall weight of the composition;
(i) applying a composition comprising microfibrillated cellulose and at least one liquid onto a surface that is sufficiently cold to at least partially freeze said composition, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream.

Preferably, in order to achieve an “up-concentration” of cellulose in liquid, i.e. to increase the solid content to, but preferably not above the preferred ranges as disclosed above, a mechanical treatment is preferred, i.e. step (0) preferably comprises a mechanical treatment.

Preferably, said mechanical treatment is selected from sedimentation, compression, filtration, such as cross-flow filtration, or centrifugation.

Preferably, said mechanical treatment is performed at a temperature of from 15° C. to 90° C., preferably from 30° C. to 70° C.

### Freezing the Composition

As has been outlined above in the Background Section (prior art), the freezing methods known from the state of art do not necessarily work well for suspensions/dispersions such as microfibrillated cellulose in a solvent.

However, surprisingly it was found that a method of contact freezing can be used where relatively high temperatures are employed. In a preferred embodiment, at least the following two process conditions should be met:
building-up of a homogeneous and thin layer of the material on the cold surface and
for water as a solvent, preferred surface temperatures of at least −40 to −80 degrees.

The material to be applied to the surface is typically (depending, among others, on the solid content) a thick paste with features that best can be compared with dough. Having a fibril content of 6 to 15%, the material does typically not flow or at least not flow in accordance with a Newtonian fluid and can typically only be transported by special means, e.g. screws or belts. Means to apply the material onto a cold surface, using standard methods, e.g. doctor blades are not preferred since the slurry may freeze immediately to the surface. Embodiments to simply drop the dispersion/suspension/slurry onto the surface are not preferred since the extremely high viscosity of the material inhibits the formation of drops.

The freezing process of the invention generally involving step (i) of applying the microfibrillated cellulose onto a cold surface leads to particles which are advantageously used in fluidized bed processes.

Therefore, in accordance with the present invention, in step (i), the composition comprising MFC and at least one liquid is applied onto a cold surface with the object to at least partially freeze said composition, preferably to thoroughly freeze said composition as applied, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.

In a preferred embodiment, said surface has a temperature that is not below −150° C., preferably not below −120° C. or not below −100° C.

Preferably, the “application” according to step (i) is performed by spraying.

In a preferred embodiment of the present invention, using a special nozzle and a preferred atomization method as well as suitable means for transport, it is possible to spray the paste even at the highest concentrations. With this preferred embodiment of freezing particles, it is possible to freeze down the material at comparable high temperatures and keep the features of the network to a higher degree than with immersion freezing in liquid nitrogen. Moreover this type of process can be run with compression cooling thus is economical and it is feasible for high volumes.

Preferably, in step (i), the composition that is to be applied, preferably sprayed, onto said surface is cooled prior to said application. Further preferably, said composition is cooled below the respective ambient temperature, further preferably slightly (i.e. 1 K to 10 K) above, preferably 1 K to 5 K above the melting point of the at least one liquid, or, if the at least one liquid is a mixture of two or more liquids, the melting point of the liquid with the lowest melting point.

Since the cellulose microfibers present in the at least one liquid have insulating properties, in particular at higher concentrations (higher solid content), it was found that a comparatively low temperature of the surface is needed in order to ensure the formation of a frozen film of said composition on said surface within a reasonably short period of time thus ensuring superior properties of the dried microfibrillated cellulose.

Importantly, the fact of having insulating small particles at a comparatively high concentration dispersed throughout a liquid is a particular problem encountered in compositions comprising microfibrillated cellulose since a short freezing time is not only desirably for economical process reasons but also, as was only found in the context of the present invention, to ensure improved reconstitution properties in regard to the dry end product.

Specifically, it was found that specifically performing the freezing-step as defined in step (i) is crucial for the end-quality of the microfibrillated cellulose to be obtained according to step (iv).

Without wishing to be bound to a theory, it is believed that the freezing speed, which depends on the temperature of said surface, and the fact that a surface freezing technique is used and not an immersion technique, defines the growth of liquid crystals in the material sprayed onto said surface. In general, the higher the freezing speed, the finer the liquid crystals formed on said surface.

According to a preferred embodiment of the invention, preferably, the frozen structure formed on said surface consists of particularly small and fine crystals. This is important since larger crystals are believed to disrupt the three-dimensional structure that the fibrils form and which defines the characteristics of the isolated microfibrillated cellulose respectively the re-constituted microfibrillated cellulose in liquid. This applies in particular if water is used as the liquid, but also occurs in other liquids or liquid mixtures.

It has also been found that when creating predominantly amorphous crystals or larger crystals (i.e. using not sufficiently cold conditions), the viscosity of the reconstituted microfibrillated cellulose based on the dry MFC from step (iv) can be much lower than the viscosity of the microfibrillated cellulose employed in step (i) when measured at the same solid content concentration. Therefore, viscosity losses respectively losses of gel-structure may be observed, when the temperature of said surface is significantly above the threshold of 30 K below the melting point of the liquid (i.e. below −30° C. in case of water as liquid). At a temperature of the surface of e.g. only −18° C., viscosity losses respectively losses of gel-structure of more than 80% have been observed for MFC in water. The MFC in this specific example could not be re-dispersed.

Preferably, said surface in step (i) or in means (F) has a temperature of at least 30 K or 40 K or 50 K or 60 K below the melting point of the at least one liquid, or, if the at least one liquid is a mixture of two or more liquids, at least 30 K or 40 K or 50 K or 60 K below the melting point of the liquid with the lowest melting point, wherein said surface has a temperature that is not more than 150 K below said melting point of the at least one liquid, or, if the at least one liquid is a mixture of two or more liquids, not more than 150 K below the melting point of the liquid with the lowest melting point, and wherein said surface has a temperature that is not below −170° C.

Preferred ranges are 30 K to 150 K, 30 K to 120 K, 30 K to 100 K, 40 K to 150 K, 40 K to 120 K, 40 K to 100 K, 50 K to 150 K, 50 K to 120 K, 50 K to 100 K, 60 K to 150 K, 60 K to 120 K, 60 K to 100 K below the respective melting point, respectively. A range of 30 K to 100 K or 40 K to 120 K below the melting point(s) is particularly preferred.

In an embodiment in which said at least one liquid is water or comprises water as the liquid with the lowest melding point, the temperature of said surface is preferably from −30° C. to −150° C., preferably from −40° C. to −140° C. Still more preferred is a temperature of from −60° C. to −120° C. Temperatures of from −60° C. to −100° C. are particularly preferred.

All temperature ranges given above equally apply for step (i) and for means (F).

Preferably, the required low temperature of said surface is achieved by means of a cooling cascade involving a “high temperature” loop and a “low temperature” loop, further preferably employing two reciprocating compressors and a cooling fluid on silicon base.

Therefore, means (F) of the device according to the present invention preferably comprises (and step (i) preferably includes) the use of a cooling cascade involving a high temperature loop and a low temperature loop, further preferably employing two reciprocating compressors and a cooling fluid on silicon base.

Preferably, the low temperature of the surface is established by means of a cooling cascade comprising at least two cooling circuits that are capable of cooling said surface to a temperature of −170° C. to −30° C.

Preferably, each circuit comprises a compressor, an evaporator, expansion valves, and a condenser.

The interface of said two circuits preferably comprises a cascade cooler. In a first stage, the “high temperature” circuit cools the surface down to a temperature preferably of from −60° C. to −20° C., and the “low temperature circuit” further reduces the temperature to a range of −170° C. to −70° C., preferably −130° C. to −70° C.

In accordance with a preferred embodiment of the present invention, the refrigerant used in the low temperature circuit, preferably ethane, is condensed by evaporating high temperature circuit refrigerant, preferably propane, in the cascade cooler, i.e. the refrigerating effect of the high-temperature circuit is used to remove heat of condensation from the low temperature circuit. In this way, only the evaporator with the lowest evaporating temperature generates the refrigerating effect. Depending on the compression ratios in the circuits of the cascade system, the refrigerant can be compressed in several stages. Preferably, reciprocating compressors are used for compressing.

In a preferred embodiment, using the low temperature established in the low temperature circuit, said secondary refrigerant, preferably a silicone oil or a silicone polymer, is cooled down. By means of said secondary refrigerant, the cold surface of means (F) is cooled to the desired temperature.

Accordingly, in one embodiment, said freezing apparatus comprises in addition to means (F) at least the following means:
(F′) a cooling cascade for means (F) comprising at least two cooling circuits capable of cooling said surface to a temperature of from −170° C. to −30° C.

Employing a cooling cascade in the method and device of the invention is beneficial over the known technology for shock-freezing, which is based on the use of expensive liquid nitrogen. In a conventional freezing machine, e.g. a belt freezer, spiral freezer, and the like, approximately 1.5 liters of expensive liquid nitrogen are needed to freeze 1 kg of water. These methods are uneconomical if applied to shock-freezing of microfibrillated cellulose in liquids compared to the use of compressors as used for achieving the desired low temperature in the cooling cascade as presently preferred.

In a preferred embodiment, the surface in step (i) of the method or in means (F) of the device is a continually moving surface.

More preferably, said continually moving surface comprises a continually rotating surface or is part of or is a continually rotating surface.

Preferably, said rotating surface is a rotating cooling belt or a rotating drum or a rotating or otherwise continually moving disc, ring or cylinder.

Preferably, said surface comprises a material that performs under low temperature, i.e. is suitable in regard to heat conductance, heat capacity and/or mechanical properties, and is mechanically sufficiently stable to maintain functionality in the required temperature range.

Preferably, the thermal conductivity of the material of said surface is greater than 30 W m⁻¹ K⁻¹, preferably greater than 50 W m⁻¹ K⁻¹, further preferably greater than 100 W m⁻¹ K⁻¹, further preferably greater than 300 W m⁻¹ K⁻¹.

Preferably, the surface of means (F) or the surface as used in step (i) of the process is a metallic surface or a ceramic surface, or any mixture of at least two of these materials. Preferably, said material comprises or consists of copper, brass, aluminium, aluminium or copper alloys, Al or Boron nitride and the like.

Preferably, the frozen layer formed in step (i) is kept comparatively thin in order to make sure that the above addressed insulating effect does not negatively affect the freezing rate and therefore the capability of the dried MFC to be reconstituted without unwanted loss of viscosity/gel-like properties.

Preferably, the thickness of the frozen layer is kept in a range of from 0.01 mm to 3 mm, preferably 0.01 mm to 1 mm, more preferred 0.05 mm to 0.2 mm, even more preferred in a range of from 0.07 mm to 0.15 mm.

In step (i) or in means (A) the composition is preferably applied to said cold surface by using a spraying means. Preferably, a nozzle or atomizer or the like is used for said means, respectively in said step.

Preferably, a flat-jet nozzle or a flat-spray nozzle adapted to the high viscosity of the microfibrillated cellulose composition is used in step (i) or as means (A).

Flat-jet nozzles as known in the art are one-component nozzles, wherein the jet is adjusted by the overall pressure applied. The term “one-component nozzle” means that only one component is passed through said nozzle. If such a one-component nozzle is used in the method according to the invention, the high viscosity of the composition to be applied onto said surface requires a high spraying pressure, which in turn accelerates the jet. As a consequence, material may splash on the surface which may result in a non-homogeneous layer of frozen composition on said surface. Said non-homogeneous layer may adversely affect the subsequent method steps and thus the characteristics of the microfibrillated cellulose obtained in step (iv).

Therefore, preferably, in accordance with the present invention, a so-called two-component nozzle, preferably a flat-jet nozzle, is used in step (ii) or as means (A). This allows for reduced values of the spraying pressure.

The term “two-component nozzle” means that two components are simultaneously or concurrently passed through said nozzle. Herein, said two components comprise (a) compressed fluid and (b) a composition of microfibrillated cellulose in liquid.

Preferably, said compressed fluid is air.

In a preferred embodiment, said compressed fluid, preferably compressed air, and said composition are externally mixed after passage through said nozzle.

By using such a nozzle, spraying of said composition having a droplet size of 100-1000 μm, preferably 500 μm to 700 μm is possible, which results in an advantageous distribution of fine crystals.

The distance from which the composition is sprayed onto said surface is preferably in the range of from 100 mm to 1000 mm, further preferably 400 mm to 600 mm, further preferably approximately 500 mm.

### Removing Frozen Particles

Subsequent to preparing a frozen layer of the desired thickness as described above in regard to step (i), the frozen product formed in step (i) on said surface is removed in step (ii) by means for removing (R) that preferably result in solid (“frozen”) particles comprising microfibrillated cellulose in at least one liquid.

Preferably, said means (R) for removing frozen composition from said surface resulting in frozen particles is a means that removes frozen composition by mechanical impact.

Preferably, said means (R) comprises a scraper or is a scraper, in particular a static scraper. In an alternative embodiment, the scraper (i.e. the means for removing) is moving and the cold surface of means (F) is static/stationary.

The term “static scraper” encompasses a scraper that has a defined distance from said surface.

Preferably, the MFC in at least one liquid is applied onto the cold surface of means (F) and forms a layer on the drum; the layer thickness is defined by the volume of material pumped/sprayed onto the cold surface. A higher volume and thickness is preferably reached with larger droplets; the homogeneity of the layer (i.e. variations in thickness) is preferably defined by the droplet size (in case the droplets are too small, the necessary layer thickness may not be reached; in case the droplets are too big, an uneven layer and maybe inhomogeneous freezing conditions may result).

Preferably, the layer is instantly frozen (shock freezing). In an exemplary run, it was found that there is an increase in volume of the material when transitioning from the liquid to solid state of about 9%; this results in cracking of the frozen layer (depending on the freezing speed); the already loosened flakes are then removed by the scraper; the scraper preferably does not touch the surface but only offers resistance for the flakes so that they are peeled off.

In another embodiment of the invention, if said surface is a rotating surface such as a cooling belt or a rotating drum, the means (R) for removing said frozen composition from said rotating surface (resulting in frozen particles) is gravitation. Frozen particles are preferably produced at the turning points of a rotary surface when the frozen composition falls down from said rotating surface due to the influence of gravitation, and breaks into pieces, respectively particles.

Therefore, in a preferred embodiment, gravity is used as (one or as the only) means (R). This applies, in particular, if the surface is particularly cold, for example 60 K or more below the melting point of the liquid.

It is also possible to use any combination of mechanical means, for example a scraper and gravitation, as means (R).

By using said static scraper and adapting its positioning accordingly, particles in the form of thin frozen composition particles (“frozen flakes”) of a thickness of approximately 100 μm to 200 μm and irregular shape can be obtained, in accordance with a preferred embodiment. However, other particle sizes, such as 50 μm to 150 μm or 200 μm to 500 μm may also be obtained.

### Sieving/Grinding the Particles

Prior to steps (iii) and (iv) and in order to improve the characteristics of the microfibrillated cellulose obtained in step (iv), it is preferred to grind and/or classify and/or sieve the particles formed in step (ii) in order to obtain a material that is as homogeneous as possible or has as homogeneous/narrow a particle size distribution as possible.

Therefore, in an optional but preferred step (ii′) of the present invention, the material formed in step (ii) is passed through a sieve or classifying device, such as, preferably, a rotary sieve, to select a predefined upper limit of the particle size, preferably from 0.1 mm to 10 mm, further preferably from 1 mm to 3 mm in respect to the longest diameter or length (i.e. the “characteristic” length/diameter).

Particles of a larger diameter are preferably discarded or milled to result in smaller particles that can then be fed back into the process.

After step (ii), respectively when the particles have passed optional step (ii′), the size of the particles is increased according to optional step (iii).

### Size Increase

In the process of the present invention which strives, among others, for a particularly effective way of drying MFC, it was found that the drying in step (iv) can be sped up and be made more efficient in regard to energy consumption if porous “mega”-particles are created out of the primary particles obtained from step (ii) or step (ii′). In essence, this means that the particle size, in particular the average particle size is increased.

In some of the embodiments described above, the particles may have a high surface area and low thickness, thus water can be removed easily. However, in some embodiments, their mass may be low which in turn limits the air speed in fluidization, meaning the water cannot be transported away in the most efficient manner. A way to overcome that disadvantage is to increase the particle mass by attaching them to each other without melting them, forming aggregates. These particles have to have a higher mass but nevertheless a porous structure. Possible processes for this size increase are, among others: low pressure extrusion, granulation in a fluidized bed, pelletizing, granulation in mixers, drums and the like.

In accordance with this preferred embodiment of the present invention, said increase in particle size is preferably achieved by means of forming “aggregates” or “granulates” that are based on the smaller primary particles obtained from step (ii) or step (ii′). This means that said preferred step of increasing the particle size is based on “gluing” primary particles together to result in granules.

As will be discussed below, this increase in particle size allows for higher gas stream velocities in the drying step (iv) while maintaining a fluidized bed, which is a preferred way to “contain” the particles.

Therefore, the problem according to the present invention, and others, is/are also solved by any method for drying microfibrillated cellulose as described herein, additionally comprising at least the following steps:
(ii′) optionally classifying or grinding the frozen particles from step (ii);
(iii) increasing the size of the frozen particles formed in step (ii) or step (ii′).

Preferably, increasing the particle size in step (iii) is performed by adding a small amount of at least one liquid, or a composition comprising microfibrillated cellulose and at least one liquid, to said particles from step (ii) or step (ii′).

This addition of liquid is preferably adjusted to be just enough to allow particles to freeze together thus increasing the size of the particles.

Preferably, in step (iii), the average particle size is increased by a factor of at least 2, further preferably by a factor of at least 4, further preferably by a factor of at least 8. Such a size increase renders the particles heavier and thus allows to increase the space velocity of the cold gas used for drying without removing or aiding in removing the particles from their respective containment.

Preferably, step (iii) is performed in means, preferably containing means (C) that allow for keeping the particles in a constant or perpetual motion, preferably in a constant rotational motion.

Preferably, said constant or perpetual motion is achieved in a fluidized bed, further preferably in a spouted fluidized bed.

### Drying of the Frozen Particles

As discussed above in the Background Section, drying of MFC in standard freeze dryers (i.e. applying a vacuum and cooling the particles) is known from the literature and patents.

The main challenge for drying MFC on industrial scale is the cost for drying and the equipment. Standard freeze dryers are meant for products with highest value and comparatively low volumes, e.g. pharmaceuticals. They require massive investments in the equipment and infrastructure and running them is costly. That is why they cannot be used for cellulose-based commodities such as microfibrillated cellulose, which are of medium value and require a certain production volume to be economically viable.

However, the requirements for medium value commodities are met by drying step (iv) in accordance with the present invention.

Cold air drying (e.g. in a fluidized bed) has previously not been employed for microfibrillated cellulose and is known on the lab-scale and for high value products such as pharmaceuticals (U.S. Pat. No. 4,608,764).

Therefore, subsequent to step (ii) or subsequent to optional step (ii′) or subsequent to optional step (iii), frozen particles are dried according to step (iv) by subjecting them to a cold moving gas stream, preferably by subjecting them to a cold moving air stream.

Preferably, step (iv) is performed so that convection plays a role as the mechanism for drying, preferably plays the predominant role as the mechanism for drying. Preferably, convection drying is seconded by sublimation drying.

Preferably, step (iv) is performed in means that allow for keeping particles in a constant or perpetual motion, preferably in a constant rotational motion. Preferably, said means are means (C) of the device according to the present invention.

Preferably, said constant or perpetual motion is achieved in a fluidized bed, further preferably in a spouted fluidized bed.

Further preferably, the fluidized bed is achieved by the same fluid that functions as the fluid for drying, i.e. by said cold moving gas stream, preferably said cold moving air stream.

In a preferred embodiment, means (C) is or comprises a drying tower.

Accordingly, in a preferred embodiment of the method of the invention, step (iii) or step (iv), or step (iii) and step (iv), are performed in a fluidized bed.

In order to achieve a steady state fluidized bed while allowing for rapid drying in step (iv), i.e. while allowing for high cold gas velocities, the particles should preferably be comparatively large, preferably 1 mm to 100 mm or 2 mm to 20 mm or 5 mm to 15 mm (average diameter, respectively) and should preferably be as homogeneous as possible or economically feasible in particle size distribution (PSD).

In regard to said fluidized bed, the particles formed in step (ii) or the particles formed in step (ii′) are preferably fluidized by a continuous dry air stream running perpendicular to the horizontal plane in which the frozen particles rotate.

Preferably, said cold moving gas stream in step (iv) or in means (C) and (D) is held at a temperature of less than 10 K or less than 5 K above or at the melting point or 5 K or 10 K or more below said melting point of the at least one liquid, or, if the at least one liquid is a mixture of two or more liquids, of less than 10 K or less than 5 K above or at the melting point or 5 K or 10 K or more below said melting point of the liquid with the lowest melting point, while said temperature is not more than 50 K or 40 K or 35 K or 30 K below the melting point of the at least one liquid, or, if the at least one liquid is a mixture of two or more liquids not more than 50 K or 40 K or 35 K or 30 K below the melting point of the liquid with the lowest melting point, the melting point being determined under standard conditions (i.e. at standard pressure).

Preferred ranges in this respect are +10 K to −50 K, +10 K to −40 K, +10 K to −35 K, +10 K to −30 K, +5 K to −50 K, +5 K to −40 K, +5 K to −35 K, +5 K to −30 K, 0 K to −50 K, 0 K to −40 K, 0 K to −35 K, 0 K to −30 K, −5 K to −50 K, −5 K to −40 K, −5 K to −35 K, −5 K to −30 K, respectively, centered around the (lowest) melting point (i.e. positive temperature differentials being higher than the melting point and negative temperature differentials being below the melting point).

For energy reasons, ranges from +10 K to −30 K or +5 K to −25 K or +5 K to −10 K or +5 K to −5 K around the (lowest) melting point of the at least one liquid are preferred.

In case the liquid is water or the liquid with the lowest melting point is water, the temperature of the gas used for drying and/or fluidizing, i.e. preferably of air, is below 10° C., preferably below 5° C., further preferably below 0° C. Preferably, said temperature ranges from 10° C. to −20° C., further preferably from +5° C. to −5° C.

Preferably, the frozen particles are at least partly dried in the presence of the cold moving gas stream that is already used for fluidizing said particles in step (iii).

Preferably, in order to support the drying step, a slight sub-atmospheric pressure is applied in step (iii) and/or in step (iv). Preferably, said sub-atmospheric pressure is in the range of from 0.09 MPa to 0.01 MPa (900 mbar to 100 mbar), more preferably from 0.07 MPa to 0.01 MPa (700 mbar to 100 mbar) or 0.06 MPa to 0.02 MPa (600 mbar to 200 mbar), still more preferably from 0.025 MPa to 0.035 MPa (250 mbar to 350 mbar).

It has been found that such a coarse vacuum can be effectively achieved on an industrial scale and allows for a high throughput of material to be dried, in particular in case the modus of operation is a continuous modus, i.e. not a batch modus.

Applying only “mild” sub-atmospheric pressure for drying frozen particles is a stark departure from conventional freeze-drying involving vacuum drying by means of sublimation where a relatively fine vacuum of 1 mbar or less must be established, resulting in high investment and operating costs.

The present invention is also a stark departure from conventional drying processes in fluidized beds, where a warm or hot gas is used to thermally dry the particles in the fluidized bed.

In the drying process in a fluidized bed as used in a preferred embodiment of the present invention, the drying speed is limited by the saturation of the cold gas with liquid. Therefore, it is preferred to transport as large amounts of gas as possible to remove the liquid vapor out of the system. Therefore, the amount of cold gas and/or the space velocity of the cold gas defines the capacity and/or the size of the means for containing in which the particles are dried in step (iv).

However, the applicable space velocity of the gas is limited by the fluidization features of the particles. A velocity that is too high might remove parts of the particles from the bed, thus leading to instable operating conditions.

Running means (C) in step (iv) with the preferred sub-atmospheric pressure lowers the mass of air pumped around while the air volume stays constant. The air density is lower which means less impulse is transferred to the particles at the same air speed. As a consequence, the air speed can be increased without leaving the fluidization point and no material is blown out. Moreover, at lower absolute pressure, air saturation is improved (e.g.: 1000 mbar→3.85 g/kg air, 500 mbar→7.69 g/kg air, 300 mbar→12.94 g/kg air). The energy consumption (variable cost) is affected by these operating conditions in a positive manner as well.

The drying gas preferably is run in a closed circuit and is re-cooled, preferably by means of an absorption heat pump.

The removed liquid preferably is collected by continuous adsorption, e.g. by adsorption at continuous absorber wheels that are known in the art.

In general, for drying the product, a drying time of 4 h to 6 h is preferred and indeed possible on a commercial scale using the method of the present invention. In conventional (atmospheric) freeze-drying processes, the drying time may take as long as 24 h. Therefore, the present invention allows for high throughput drying of large amounts of microfibrillated cellulose.

In a preferred embodiment, said drying according to step (iv) is performed in a device according to the present invention comprising means for containing (C) that are preferably realized as a drying tower.

Such preferred means for containing preferably comprises at least two stages. In the first stage, said particles formed in step (ii) or step (ii′) or by means (F) and (R) are fluidized. In the second stage, said particles are dried.

Preferably, the particles formed in step (ii) or step (ii′) enter the first stage of said drying tower through a rotary valve and are fluidized by a cold moving gas stream as described above. Preferably, said first stage comprises a plurality of inlet slits and exit funnels for said cold gas.

Said means for containing (C) further preferably allow for or comprise means for adding liquid to the particles formed in step (ii) or step (ii′) in order to increase the size of said particles. Preferably, said liquid is sprayed into said fluidized bed to increase the particle size as described above in regard to optional step (iii). Preferably, a nozzle or an atomizer or the like is used as an equipment for adding liquid, preferably for spraying.

After leaving the first stage of the means for containing (C), preferably the drying tower, the particles are already partly dried as described above.

Preferably, means (C) comprises a first stage for fluidizing and a second stage for drying.

Subsequent to the treatment in the first stage of the means for containing (C), preferably the drying tower, the particles having an increased particle size are transferred to the second stage of the means for containing, preferably the drying tower, and are dried using cold air as described above in conjunction with drying step (iv).

### Isolation of Dried Particles

No restrictions exist how the dried microfibrillated cellulose is removed from the means for containing (C) after the drying step (iv) has been completed.

The dried microfibrillated cellulose product isolated in optional step (v) preferably has a liquid content of less than 50%, preferably less than 20%, preferably below 10% by weight based on the total amount of microfibrillated cellulose and liquid. The product isolated in step (v) may be either directly packed or ground to finer particles depending on the application and customer specifications.

### Overall Processing Conditions

In a preferred embodiment of the invention, the method according to the present invention is continuous.

The term “continuous” encompasses the simultaneous performance of at least steps (i) to (iv) concurrently with raw material entering step (i) and dried microfibrillated cellulose product being dried in step (iv). However, said term also encompasses embodiments of the method, in which only at least two of the steps are continuous, i.e. only at least two or more steps are performed simultaneously.

### EXAMPLES

For all examples described below, MFC produced according to following procedure was used: 200 kg of pulp in water at 3.5 wt-% is circulated through a refiner (Andritz 12-1c Laboratory Refiner) for about 90 min at a flow rate of 5 m³/h. Subsequently, the material is diluted to 2 wt-% and passed 2 times through a homogenizer (Microfluidics M-700) at 2000 bar.

The material is dewatered using a vacuum filter (Larox Pannevis RT) to a solid content of about 8 wt-% resulting in a highly viscous paste.

The freezing was performed either manually using liquid nitrogen or on a freezing drum (BUUS PBF 4000) or using a flat-jet nozzle for application of the paste to the drum (Schlick Mod. 930, Form 7-1 Pro ABC). In the latter procedure, the material is atomized with 300 g/min forming a film of about 1 mm. The flakes are removed from the drum by a scraper and subsequently ground and sieved so that a distribution of 4 to 10 mm flakes is reached.

For drying, a laboratory freeze dryer (Christ Delta 1-24 LSC) is used or a lab batch fluidized bed operated with dry cold air (Glatt ProCell 5). For each test, 1 kg of frozen particles are dried. The drying time is 72 h at 1.9 mbar and at a shelf temperature of 30 degrees Celsius in the Christ dryer. The drying time in the fluidized bed is 5 h at an air inlet temperature of −2.5 degrees and an air mass stream of 140 Kg/h on the average. The residual moisture in the samples is about 5 wt-%.

The rheological characterization (“Borregaard method” as used below) is performed on a Physica MCR 101 rheometer equipped with a PP50/P2 serrated upper plate and a conventional lower plate. A 1 mm gap between the plates is used. The rheology is measured using the following parameters:
a. Amplitude gamma: 0.015 . . . 30% on log-scale
b. Frequency: 1 Hz
c. Temperature: 20° C.
d. Time setting: 30 meas. points, no time setting

The results are presented as the complex viscosity as a function of shear stress. The plateau level of the complex viscosity is used for comparison between samples as discussed below.

The samples are prepared as follows. Measure the dry content of the POF suspension/dried POF using a halogen moisture analyser at 190° C. Dilute the sample by adding water to the MFC suspension so the final concentration will be 1.4 wt % and the total amount is 30 g. Prepare the diluted samples in 50 ml test tubes. Mix with an ultra turrax high speed mixer for 4 min at 20 000 rpm. Let the sample equilibrate for 24 hours at a shaking board prior to rheological measurement.

Surface area measurements were performed on a Micromeritics TriStar II. The dried material is prepared using a Micromeritcs VacPrep station at 80 degree Celsius for one hour.

### Example 1 (Comparative Example)

about 1 kg of MFC paste was filled into a freezing dish of 360 mm diameter and 32 mm rim height; the paste was distributed with a spatula forming a layer of about 10 mm.

Subsequently, the dish was put into a deep freezer and frozen down at −36 degree Celsius. The material was removed from the freezer and put into a vacuum freeze dryer.

The dried material had the appearance of a plastic film and was solid. After breaking and grinding it was not possible to re-disperse it in water. Consequently no analytics was done.

This comparative Example shows that conventional deep freezing does not lead to dried microfibrillated cellulose that is redispersible in water.

### Example 2 (Comparative Example)

about 1 kg of MFC paste was filled into a freezing dish of 360 mm diameter and 32 mm rim height; the paste was distributed with a spatula forming a layer of about 10 mm.

Subsequently, the dish was filled with liquid nitrogen and frozen down to −196° C. During the process liquid nitrogen was added when most of it had evaporated. Moreover the forming ice layer was manually broken to increase the freezing speed. Ice particles of about 5 to 10 mm in size were formed.

After that the dish was put into a vacuum freeze dryer and dried. The dried granules had the appearance of styrofoam and were highly porous. The granules were re-dispersible in water.

The complex viscosity according to the Borregaard method showed a value of 26 Pas on the plateau level. The Nitrogen adsorption method according to BET gave a value of 23 m²/g.

This comparative Example shows that the expensive method of deep (shock) freezing in liquid nitrogen leads to dried microfibrillated cellulose that is redispersible in water.

### Example 3 (Partially in Accordance with the Present Invention)

MFC paste was sprayed onto a drum with a surface temperature of −80 degree Celsius. The material formed a film on the surface and froze within seconds.

Subsequently, the flakes were put into a vacuum freeze dryer and dried.

The dried flakes had the appearance of thin paper parts and were re-dispersible in water. The complex viscosity according to the Borregaard method showed a value of 23 Pas on the plateau level. The Nitrogen adsorption method according to BET gave a value of 26 m²/g.

This Example partially in accordance with the invention shows that much higher (and therefore less expensive to achieve) temperatures can be used to freeze the microfibrillated cellulose suspension to be dried if the microfibrillated cellulose is applied to a cold surface in accordance with step (i) of claim 1.

### Example 4 (Fully in Accordance with the Invention)

MFC paste was sprayed to a drum with a surface temperature of −80 degree Celsius. The material formed a film on the surface and froze within seconds.

Subsequently, the flakes were put into the fluidized bed dryer and dried at a temperature of −2.5° C.

The dried flakes had the appearance of thin paper parts and were re-dispersible in water. The complex viscosity according to the Borregaard method showed a value of 25 Pas on the plateau level. The Nitrogen adsorption method according to BET gave a value of 27 m²/g.

This Example that is fully in accordance with the invention shows that even better values for the plateau viscosity and the surface area can be achieved if also step (iv) of claim 1 is applied, i.e. the expensive and difficult to control step of freeze drying is replaced by drying the frozen flakes in a cold moving gas stream.

### Example 5 (Fully in Accordance with the Invention)

MFC paste was sprayed to a drum with a surface temperature of −80 degree Celsius. The material formed a film on the surface and froze within seconds.

Subsequently, the flakes were put into the fluidized bed dryer and dried at an air inlet temperature of +5 degrees Celsius. The dried flakes had the appearance of thin paper parts and were re-dispersible in water.

The complex viscosity according to the Borregaard method showed a value of 29 Pas on the plateau level. The Nitrogen adsorption method according to BET gave a value of 19 m²/g.

This example shows that despite the comparatively high (an therefore very economical) temperature of 5 degrees Celsius above zero (for water as the solvent), acceptable values for the viscosity and the surface area result. Examples 4 and 5 show that it is possible to adapt the atmospheric freeze drying processes known from the art to produce high volumes of dried MFC at acceptable quality and cost. Example 5 shows that it is possible to increase the temperature of inlet air up to levels above 0 degree. It was a surprise that the quality of the product was still acceptable (and therefore very economical) at air inlet temperatures up to 5° C. This enables the person skilled in the art, in a preferred embodiment, to choose the temperature range for the dryer, depending which product quality is required. This increases the capacity of the dryer and lowers the cost.

As is shown in the Examples in accordance with the present invention as discussed above, it is possible to use the synergies stemming from the use of frozen particles (“flakes”) or flake aggregates in order to improve capacity and lower the cost.

In a preferred embodiment, it is possible to use an adsorber for drying of the air combined with a heat pump for energy recovery and all other possible means for energy saving. Furthermore, Continuous the preferred embodiment of a multi stage fluidized bed dryer allows to use the process air in a loop as efficient as possible.

Overall, it was found that the quality in terms of surface area is better than with standard methods (liquid Nitrogen freezing and vacuum freeze drying). Units with capacities up to 1000 ton of dry MFC a year can be built, at investment costs much lower than those for standard freeze drying.

1. Method for drying microfibrillated cellulose, said method comprising at least the following steps:
(i) applying a composition comprising microfibrillated cellulose and at least one liquid onto a surface that is sufficiently cold to at least partially freeze said composition, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(ii) removing frozen composition formed in step (i) from said surface resulting in frozen particles;
(iii) optionally increasing the size of frozen particles formed in step (ii);
(iv) drying frozen particles formed in step (ii) or in step (iii) comprising: subjecting said particles to a cold moving gas stream.

2. Method of claim 1, comprising at least the following additional step:
(v) isolating dried microfibrillated cellulose formed in step (iv).

3. Method of claim 1 or 2, wherein said at least one liquid comprises water or is water, or wherein said at least one liquid is an organic solvent or comprises an organic solvent.

4. Method of claims 1 to 3, wherein said cold moving gas stream used in step (iv) is a cold moving air stream.

5. Method of any one of the preceding claims, wherein in step (i), the concentration of microfibrillated cellulose in the at least one liquid, i.e. the solid content of microfibrillated cellulose in the composition, is from 2% to 15% by weight of microfibrillated cellulose based on the total amount of microfibrillated cellulose and liquid, or is from 3% to 10%, or is from 5% to 9% by weight.

6. Method of any one of the preceding claims, wherein, after step (ii), in step (ii′), particles are passed through a sieve or a classifying device in order to homogenize the particle size distribution.

7. Method of any one of the preceding claims, wherein step (iii) or step (iv), or step (iii) and step (iv), is or are performed in a fluidized bed.

8. Method of any one of the preceding claims, wherein step (iv) is performed under a pressure of from 0.09 MPa to 0.01 MPa (900 mbar to 100 mbar), or from 0.06 MPa to 0.02 MPa (600 mbar to 200 mbar).

9. Method of any one of the preceding claims, wherein steps (i) to (iv) are performed in a semi-continuous in a or a continuous operation mode.

10. Device for drying microfibrillated cellulose, said device at least comprising:
(F) means comprising a surface that is sufficiently cold to at least partially freeze a composition comprising microfibrillated cellulose and at least one liquid, wherein said surface has a temperature that is not more than 150 K below the melting point of the at least one liquid, or, if the at least one liquid is a mixture of two or more liquids, not more than 150 K below the melting point of the liquid with the lowest melting point, and wherein said surface has a temperature that is not below −170° C.;
(A) means for applying said composition comprising microfibrillated cellulose and at least one liquid onto means (F);
(R) means for removing frozen composition from said surface of means (F) and for forming frozen particles;
(C) means for containing frozen particles from means (R) while optionally allowing for the addition of at least one liquid or a composition comprising said at least one liquid and microfibrillated cellulose to said particles, and while allowing for access of a cold moving gas stream;
(D) means for drying particles contained in means (C), said means (D) providing a cold moving gas stream.

11. Method or device of any one of the preceding claims, wherein the surface in step (i) or in means (F) has a temperature of at least 30 K below the melting point of the at least one liquid, or, if the at least one liquid is a mixture of two or more liquids, at least 30 K below the melting point of the liquid with the lowest melting point.

12. Method or device of any one of the preceding claims, wherein said cold moving gas stream in step (iv) or in means (C) and (D) is held at a temperature of less than 10 K above the melting point of the at least one liquid, or, if the at least one liquid is a mixture of two or more liquids, of less than 10 K above the melting point of the liquid with the lowest melting point, while said temperature is not more than 50 K below the melting point of the at least one liquid, or, if the at least one liquid is a mixture of two or more liquids not more than 50 K below the melting point of the liquid with the lowest melting point.

13. Method or device according to any one of the preceding claims, wherein the microfibrillated cellulose in step (i) and/or in means (A) is present in particulate form and said microfibrillated cellulose is suspended or is dispersed or is present as a colloid in said at least one liquid.

14. Method or device according to claim 13, wherein said microfibrillated cellulose in particulate form has a characteristic length in the range of 1 μm to 5,000 μm, preferably 100 μm to 3000 μm, and/or wherein said microfibrillated cellulose has a characteristic diameter in the range of 1 nm to 100 nm, preferably 5 nm to 50 nm.

15. Method or device according to any one of the preceding claims, wherein said surface has a temperature that is not below −150° C. or −120° C. or −100° C.
